(19) United States
(12) Patent Application Publication
(10) Pub. No.: US 2010/0003531 A1
(43) Pub. Date: Jan. 7, 2010

(54) Novel polyimide film with improved adhesiveness

(76) Inventors: Takashi Kikuchi, Otsu-shi (JP); Hisayasu Kaneshiro, Uji-shi (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/460,605

(22) Filed: Jul. 22, 2009

Related U.S. Application Data
(63) Continuation of application No. 11/795,222, filed on Jul. 12, 2007.

(30) Foreign Application Priority Data
Jan. 18, 2005 (JP) 2005-010961

(51) Int. Cl. C08G 69/26; B32B 15/04

(52) U.S. Cl. 428/457; 528/332

(57) ABSTRACT

Disclosed is a polyimide film which exhibits high adherability to a metal foil via an adhesive layer containing a thermoplastic polyimide without requiring a special surface treatment. Specifically disclosed is a non-thermoplastic polyimide film obtained by imidizing a polyamic acid solution which is obtained from aromatic diamine and aromatic acid dianhydride. This non-thermoplastic polyimide film is characterized in that the aromatic diamine contains 4,4′-diaminodiphenylether and bis{4-(4-aminophenoxy)phenyl}propane, and the solution containing a polyamic acid is obtained by a specific production method.

### CROSS REFERENCE TO RELATED APPLICATION(S)

This application is a continuation of application Ser. No. 11/795,222, filed Jul. 12, 2007 and published as U.S. Patent Application No. 2008/0097073 A1 on Apr. 24, 2008.

### TECHNICAL FIELD

The present invention relates to a novel polyimide film having a high adherability (ability of allowing adhesion thereto) without requiring a special surface treatment to its film surface.

### BACKGROUND ART

The recent trends toward lighter, smaller, and higher-density electronic products have increased the demand for various printed circuit boards. In particular, the demand for a flexible printing wiring board (hereinafter, also referred to as “FPC)”) has shown a notable increase. The flexible printed wiring board is constituted from an insulating film and a circuit formed from a metal foil disposed on the film.

Typically, the flexible metal-clad laminate, from which the flexible printing circuit board is produced, is produced by bonding a metal foil onto a surface of a substrate with an adhesive material under heating and pressure, the substrate being a flexible insulating film made from an insulating material of various kinds. Polyimide films and the like are preferred as the flexible insulating film.

Generally, polyimide films are prepared by (i) casting, on a support, a solution of a polyamic acid obtained by reacting a diamine and an acid dianhydride, (ii) volatilizing off a solvent therefrom to obtain a gel film, and (iii) thermally and/or chemically imidizing the gel film. There have been various studies on structures and imidation conditions of the raw material monomers, namely, diamine and acid dianhydride. Nevertheless, polyimide films obtained by any of theses studies are categorized into films having very poor adherability among plastic films. In practice, the poor adherability is encountered by performing a surface treatment of various kinds (such as a corona treatment, a plasma treatment, a flaming treatment, a UV treatment, etc.) before providing an adhesive layer on the polyimide films.

While there are various hypotheses for the poor adherability of the polyimide films, it is said that formation of a weak boundary layer (WBL) on the film surface in the process of film formation is one of the causes of the poor adherability. That is, boundary peeling occurs at the WBL, thereby deteriorating the adherability. PCT (Pressure Cooker Test) or long-term heating test shows further worse adherabilities because decomposition of the WBL is facilitated in the tests. It is said that the surface treatment roughens the film surface and thereby removes the WBL, improving the adherability.

Meanwhile, typical examples of thermosetting adhesive agents for adhering a polyimide film with a metal foil are epoxy adhesive agents, acrylic adhesive agents, etc. It is expected that requirements in properties such as heat resistance, flexibility, electric reliability, etc. will be more severe, and it will be difficult to satisfy such requirements by using such a thermosetting adhesive agent. In view of this, it has been proposed to use a thermoplastic polyimide as an adhesive material. The thermoplastic polyimide is, however, poorer in flowability than thermosetting resins. As a result, the thermoplastic polyimide cannot get hold of a material and thus is poor in adhesiveness compared with the thermosetting resins. Therefore, the polyimide film poor in adherability cannot be laminated with sufficient adhesion strength with a metal foil via a thermoplastic polyimide layer poor in adhesiveness.

To overcome this problem, various attempts have been made, such as (i) the use of a surface-treated film, (ii) flowability improvement in the thermoplastic polyimide in the adhesive layer by giving the thermoplastic polyimide a lower glass transition temperature, (iii) simultaneous formation of a core layer and the adhesive layer thereby to avoid the formation of WBL (see Patent Citation 1).

However, the use of a surface-treated film is associated with such problems as an increase in a number of processes and a higher cost due to the film surface treatment. The thermoplastic polyimide with the lower glass transition temperature has a problem in that it is poor in heat resistance. Furthermore, the simultaneous formation of the core layer and the adhesive layer is disadvantageous in that the combination of the core layer and the adhesive layer cannot be changed easily.

### [Patent Citation 1]

Japanese Patent Application Publication, Tokukaihei, No. 3-180343

### DISCLOSURE OF INVENTION

The present invention is accomplished in view of the aforementioned problem. An object of the present invention is to provide a polyimide film that, without requiring a special surface treatment, shows a high adherability to a metal layer, especially to provide a polyimide film that, without requiring a special surface treatment, shows a high adherability to a metal foil to which the polyimide film is laminated via an adhesive layer. In particular, an object of the present invention is to provide a polyimide film that shows a high adherability to a metal foil to which the polyimide film is laminated via an adhesive layer containing a thermoplastic polyimide.

As a result of diligent studies to attain the objects, the inventors of the present invention uniquely found that a dramatically high adherability could be attained in a polyimide film obtained by a particular manufacturing method in which a diamine component including 4,4′-diaminodiphenylether and bis{4-(4-aminophenoxy)phenyl}propane. The present invention is accomplished on this finding.

The inventors of the present invention have developed a polyimide film in which a dimensional change, which would occur in a production process of a flexible copper-clad laminate for example, can be prevented, especially a polyimide film which suppresses thermal distortion that would occur in materials in a lamination method. As a result of further studies, the inventors found that use of 4,4′-diaminodiphenylether instead of 3,4′-diaminophenyl ether attains better productivity of a film without scarifying the above-mentioned excellent properties of the film.

With any of the novel polyimide films below, the present invention can attain the object.

1) A non-thermoplastic polyimide film prepared from a solution containing a polyamic acid obtained by reacting aromatic diamines and aromatic acid dianhydrides,

the aromatic diamines including 4,4′-diaminodiphenylether and bis{4-(4-aminophenoxy)phenyl}propane, and the solution containing the polyamic acid being produced by a producing method including the steps of:

(A) preparing a flexible prepolymer having an amino group or an acid dianhydride group on each end by reacting, in an organic polar solvent, an aromatic acid dianhydride component and an aromatic diamine component, one of which is greater in molar amount than the other; and

(B) synthesizing a solution containing a polyamic acid by (i) adding an aromatic acid dianhydride component and an aromatic diamine component to the solution containing the flexible prepolymer obtained in the step (A) to attain a substantial equimolar ratio of the aromatic acid dianhydride component and the aromatic diamine component in an overall production process of the solution containing the polyamic acid, and (ii) reacting the aromatic acid dianhydride component and the aromatic diamine component.

2) The non-thermoplastic polyimide film as set forth in 1), wherein the aromatic diamine component used in the step (A) is a flexible diamine.

3) The non-thermoplastic polyimide film as set forth in 2), wherein the aromatic diamine component used in the step (B) is a rigid diamine.

4) The non-thermoplastic polyimide film as set forth in 2) or 3), wherein the flexible diamine comprises 4,4′-diaminodiphenylether and/or bis{4-(4-aminophenoxy)phenyl}propane.

5) The polyimide film as set forth in 4), wherein 4,4′-diaminodiphenylether is used by 10 mol % or more of the whole diamine component used in the overall production process of the solution containing the polyamic acid.

6) The polyimide film as set forth in 4) or 5), wherein bis{4-(4-aminophenoxy)phenyl}propane is used by 10 mol % or more of the whole diamine component used in the overall production process of the solution containing the polyamic acid.

7) The polyimide film as set forth in any one of 1) to 4), wherein benzophenonetetracarboxylic dianhydride is used as the aromatic acid dianhydride in the step (A).

8) The polyimide film as set forth in 7), wherein the benzophenonetetracarboxylic dianhydride is used by 5 mol % or more of the whole acid dianhydride component used in the overall production process of the solution containing the polyamic acid.

9) The polyimide film as set forth in any one of 1) to 8), wherein the flexible prepolymer obtained in the step (A) is a thermoplastic block component.

10) The polyimide film as set forth in any one of 1) to 9), wherein a laminate prepared by laminating the polyimide film with a metal foil via an adhesive layer containing a thermoplastic polyimide has a metal-foil peel strength of 15 N/cm or more at 90° peeling and of 10 N/cm or more at 180° peeling, where the polyimide film is not surface-treated.

11) The polyimide film as set forth in any one of 1) to 10), wherein a laminate prepared by laminating the polyimide film with a metal foil via an adhesive layer containing a thermoplastic polyimide is 85% or more in metal-foil peel strengths at 90° peeling and at 180° peeling after being treated with a temperature of 121° C. and 100% relative humidity for 96 hours compared with before the treatment, where the polyimide film is not surface-treated.

12) The polyimide film as set forth in any one of 1) to 10), wherein a laminate prepared by laminating the polyimide film with a metal foil via an adhesive layer containing a thermoplastic polyimide is 85% or more in metal-foil peel strengths at 90° peeling and at 180° peeling after being treated with a temperature of 150° C. for 500 hours compared with before the treatment, where the polyimide film is not surface-treated.

### BEST MODE FOR CARRYING OUT THE INVENTION

The present invention attains an excellent adherability as described above, especially, an excellent adherability for the use of an adhesive layer containing a thermoplastic polyimide. The present invention attains such an excellent adherability by using 4,4′-diaminodiphenylether and bis{4-(4-aminophenoxy)phenyl}propane as diamine components which are raw materials of a polyimide film, and specifying a polymerization method for a polyamic acid, which is a precursor of a polyimide.

Embodiments of the present invention is described below.

### (1. Production of Polyamic Acid)

In general, a polyamic acid, which is a precursor of a polyimide for use in the present invention, is produced by dissolving an aromatic diamine and an aromatic acid dianhydride of substantially equimolar amounts in an organic solvent, and stirring the thus obtained organic solvent solution of the polyamic acid under controlled temperature conditions until completion of polymerization of the diamine and acid dianhydride. The polyamic acid solution has a concentration generally in a range of 5 to 35 wt %, and preferably in a range of 10 to 30 wt %. The concentration in these ranges gives appropriate molecular weight and solution viscosity.

In order to obtain a polyimide film having a high adherability without being subjected to a special surface treatment, it is important to use a polyamic acid solution prepared via the following steps (A) and (B):

(A) the step of preparing a prepolymer having an amino group or an acid dianhydride group on each end by reacting, in an organic polar solvent, an aromatic acid dianhydride component and an aromatic diamine component, one of which is greater in molar amount than the other; and

(B) the step of synthesizing a solution containing a polyamic acid by (i) adding an aromatic acid dianhydride component and an aromatic diamine component to the solution containing the flexible prepolymer obtained in the step (A) to attain a substantial equimolar ratio of the aromatic acid dianhydride component and the aromatic diamine component in an overall production process of the solution containing the polyamic acid, and (ii) reacting the aromatic acid dianhydride component and the aromatic diamine component.

It is important that the aromatic diamine component include 4,4′-diaminodiphenylether and bis{4-(4-aminophenoxy)phenyl}propane.

The condition “substantial equimolar ratio of the aromatic acid dianhydride component and the aromatic diamine component” is not particularly limited. For example, this condition may be such that the aromatic acid dianhydride component and the aromatic diamine component is in a molar ratio of 100:99 to 100:102. Moreover, the condition “an aromatic acid dianhydride component and an aromatic diamine component, one of which is greater in molar amount than the other” is not particularly limited. For example, this condition may be such that the aromatic acid dianhydride component and the aromatic diamine component is in a molar ratio of 100:85 to 100:95, or of 100:105 to 100:115.

Examples of the aromatic diamine, which can be used as a raw material monomer of the polyimide film according to the present invention encompass: 4,4′-diaminodiphenylpropane, 4,4′-diaminodiphenylmethane, benzidine, 3,3′-dichlorobenzidine, 3,3′-dimethylbenzidine, 2,2′-dimethylbenzidine, 3,3′-dimethoxybenzidine, 2,2′-dimethoxybenzidine, 4,4′-diaminodiphenylsulfide, 3,3′-diaminodiphenylsulfone, 4,4′-diaminodiphenylsulfone, 3,4′-diaminodiphenylether, 3,3′-diaminodiphenylether, 4,4′-diaminodiphenylether, 1,5-diaminonaphthalene, 4,4′-diaminodiphenyldiethylsilane, 4,4′-diaminodiphenylsilane, 4,4′-diaminodiphenylethylphosphineoxide, 4,4′-diaminodiphenyl N-methylamine, 4,4′-diaminodiphenyl N-phenylamine, 1,4-diaminobenzene (p-phenylenediamine), 1,3-diaminobenzene, 1,2-diaminobenzene, bis{4-(4-aminophenoxy)phenyl}sulfone, bis{4-(3-aminophenoxyl)phenyl}sulfone, 4,4′-bis(4-aminophenoxyl)biphenyl, 4,4′-bis(3-aminophenoxyl)biphenyl, bis{4-(4-aminophenoxy)phenyl}propane 1,3-bis(3-aminophenoxyl)benzene, 1,3-bis(4-aminophenoxy)benzene, 1,3-bis(3-aminophenoxy)benzene, 3,3′-diaminobenzophenone, 4,4′-diaminobenzophenone, and like substances.

The diamine used in the step (A) is preferably a flexible diamine. The step (A) with such a flexible diamine produces a prepolymer that will become a thermoplastic block component (thermoplastic portion) of the polyimide easily. The reaction in the step (B) with such a prepolymer and the subsequent film formation make it easy to obtain a polyamic acid having a molecular chain in which the thermoplastic portions are present partly. This allows the polyimide film to have the thermoplastic portions partly. In the present invention, what is meant by the flexible diamine is diamines having a soft structure such as ether group, sulfone group, ketone group, sulfide group, or the like. Preferably, the flexible diamine is represented by the General Formula (1):

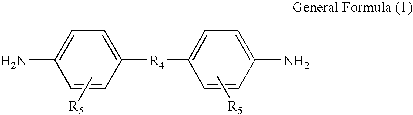

where R₄ is a group selected from the group consisting of divalent organic groups shown in General Formula Group (1):

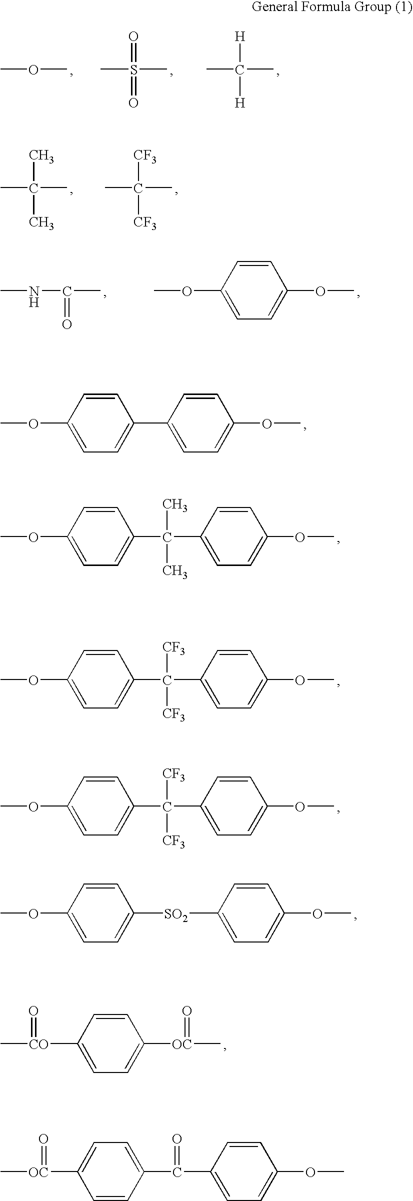

and R₅ is identically or independently a group selected from the group consisting of H—, CH₃—, —OH, —CF₃, —SO₄, —COOH, —CO—NH₂, Cl—, Br—, F—, and CH₃O—.

It is preferable that the step (A) be carried out with 4,4′-diaminodiphenylether and/or bis{4-(4-aminophenoxy)phenyl}propane as the flexible diamine. The arrangement improves the adherability to be higher and be less susceptible to environmental changes.

It has not been still unknown in details why the polyimide film obtained via these steps expresses a high adherability with no treatment. It is deduced that the flexible portions (thermoplastic portion) contained in the molecular chain partly hinders the WBL formation or makes some sort of contribution to the adhesion between the polyimide film and the adhesive layer.

Furthermore, it is preferable that the step (B) be carried out with a diamine component having a rigid structure. With this arrangement, the film finally obtained becomes non-thermoplastic. In the present invention, the diamine having a rigid structure is represented by General Formula (2):

NH₂—R₂—NH₂ General Formula (2)

where R₂ is a group selected from the group consisting of divalent aromatic groups shown in General Formula Group (2):

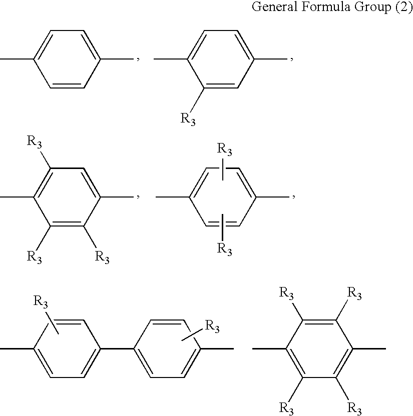

R₃ is identically or independently a group selected from the group of H—, CH₃—, —OH, —CF₃, —SO₄, —COOH, —CO—NH₂, Cl—, Br—, F—, and CH₃O—.

The diamine having the rigid structure and the flexible diamine (also referred to as “diamine having a soft structure) to use is in a molar ratio in a range of 80:20 to 20:80, preferably in a range of 70:30 to 30:70, and especially preferably in a range of 60:40 to 40:60. If the diamine having the rigid structure is used above the ratio, the resultant film will be insufficient in adherability possibly. By contrast, if the diamine having the rigid structure is used below the ratio, it will result in such a high thermoplastic property that the film will thermally soften in the film formation thereby causing film breakage.

One kind diamine or plural kinds of diamines in combination may be used as the flexible diamine, while the same is true for the diamine having the rigid structure. In the present invention, however, it is important to employ 4,4′-diaminodiphenylether as the flexible diamine. The inventors of the present invention found that the use of 4,4′-diaminodiphenylether was highly effective to attain a higher adherability. In case the 4,4′-diaminodiphenylether is employed, it is easier to use another flexible diamine in combination with 4,4′-diaminodiphenylether. It is preferable that 4,4′-diaminodiphenylether be used by 10 mol % or more of the whole diamine component. It is more preferable that 4,4′-diaminodiphenylether be used by 15 mol % or more of the whole diamine component. The above effect would not be sufficiently attained if the amount of 4,4′-diaminodiphenylether to use was less than that. As to its upper limit, 50 mol % or less is preferable, and 40 mol % or less is more preferable. If the amount of 4,4′-diaminodiphenylether to use was more than that, the resultant polyimide film would have an excessively large coefficient of thermal expansion.

Furthermore, it is also important to employ bis{4-(4-aminophenoxy)phenyl}propane as the flexible diamine (diamine having a soft structure). The use of bis{4-(4-aminophenoxy)phenyl}propane tends to lower the water absorption and coefficient of moisture expansion in the resultant polyimide film, thereby giving the polyimide film a better moisture resistance. It is preferable that bis{4-(4-aminophenoxy)phenyl}propane be used by 10 mol % or more of the whole diamine component. It is more preferable that bis{4-(4-aminophenoxy)phenyl}propane be used by 15 mol % or more of the whole diamine component. The above effect would not be sufficiently attained if the amount of bis{4-(4-aminophenoxy)phenyl}propane to use was less than that. As to its upper limit, 40 mol % or less is preferable, and 30 mol % or less is more preferable. If the amount of bis{4-(4-aminophenoxy)phenyl}propane to use was more than that, the resultant polyimide film would have an excessively large coefficient of thermal expansion, which would result in problems such as curling at laminating the polyimide film and a metal foil.

Moreover, it is preferable that the coefficient of thermal expansion of the polyimide film be in a range of 5 to 18 ppm/° C. at between 100° C. and 200° C. It is more preferable that the coefficient of thermal expansion of the polyimide film be in a range of 8 to 16 ppm/° C. at between 100° C. and 200° C.

Meanwhile, the diamine having the rigid structure may be p-phenylenediamine preferably. In case where p-phenylenediamine is employed, an amount of p-phenylenediamine to use is preferably 60 mol % or less and more preferably 50 mol % or less of the whole diamine component. As p-phenylenediamine has a small molecular weight, the polyimide prepared with p-phenylenediamine will have more imide groups (higher imide group concentration) than one prepared without p-phenylenediamine, thereby having problems in moisture resistance and the like.

Examples of acid dianhydride that can be used as a raw material monomer of the polyimide according to the present invention encompass: pyromellitic dianhydride, 2,3,6,7-naphthalenetetracarboxylic dianhydride, 3,3′,4,4′-biphenyltetracarboxylic dianhydride, 1,2,5,6-naphthalenetetracarboxylic dianhydride, 2,2′,3,3′-biphenyltetracarboxylic dianhydride, 3,3′,4,4′-benzophenonetetracarboxylic dianhydride, 2,2′,3,3′-benzophenonetetracarboxylic dianhydride, 4,4′-oxyphtharic dianhydride, 3,4′-oxyphthalic dianhydride, 2,2-bis(3,4-dicarboxyphenyl)propane dianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic dianhydride, bis(3,4-dicarboxyphenyl)sulfone dianhydride, p-phenylenebis(trimellitic acid monoester anhydride), ethylenebis(trimellitic acid monoester anhydride), bisphenol A bis(trimellitic acid monoester anhydride), and the like substances. They may be preferably used solely or in combination at an appropriate ratio.

As in the diamines, the acid dianhydrides may be classified into ones having a soft structure and ones having a rigid structure. It is preferable that an acid dianhydride having a soft structure be used in the step (A), while an acid dianhydride having a rigid structure be used in the step (B). In the present invention, the acid dianhydride having the soft structure refers to an acid dianhydride having a soft structure such as ether group, sulfone group, ketone group, sulfide group, or the like. By contrast, the acid dianhydride having the rigid structure refers to an acid dianhydride having no bonding mentioned above, but having a benzene structure or naphthalene structure with acid anhydrides bonded thereto.

Preferable examples of the acid dianhydride to be used in the step (A) encompass benzophenonetetracarboxylic dianhydrides, oxyphthalic dianhydrides, and bephenyltetracarboxylic dianhydrides. Of them, it is especially preferable to use benzophenonetetracarboxylic dianhydride. Benzophenonetetracarboxylic dianhydride is highly effective to attain higher adherability in the resultant polyimide film. It is preferable that the amount of benzophenonetetracarboxylic dianhydride be 5 mol % or more of the whole acid dianhydride component. It is more preferable that the amount of benzophenonetetracarboxylic dianhydride be 10 mol % or more of the whole acid dianhydride component. There would possibly be a case that the above effect is not attained if the amount of benzophenonetetracarboxylic dianhydride was less than that. By contrast, an upper limit of the amount of benzophenonetetracarboxylic dianhydride be preferably 30 mol % or less, and more preferably 20 mol % or less of the whole acid dianhydride component. If the amount of benzophenonetetracarboxylic dianhydride was greater than the upper limit, water absorption would be very large, thereby causing poor moisture resistance possibly. Moreover, the amount of benzophenonetetracarboxylic dianhydride greater than the upper limit would offer the film high thermoplasticity, thereby possibly causing problems such as film breakages in the film formation.

Preferable examples of the acid dianhydride to use in the step (B) encompass pyromellitic dianhydride. In case where pyromellitic dianhydride is used, the amount of pyromellitic dianhydride is preferably in a range of 40 to 95 mol %, more preferably in a range of 50 to 90 mol %, especially preferably in a range of 60 to 80 mol %. The use of pyromellitic dianhydride in an amount in these ranges makes it easy to form the resultant polyimide film and attain good coefficient of thermal expansion in the resultant polyimide film.

It is preferable that the flexible prepolymer obtained in the step (A) be a thermoplastic block component. In the other words, it is preferable that the flexible prepolymer obtained in the step (A) be such a prepolymer that it will offer a thermoplastic composition to a film of a polyimide resin obtained by an equimolar reaction of the aromatic tetracarboxylic dianhydride and the aromatic diamine compound constituting the flexible prepolymer.

Here, the “thermoplastic block component” is such a block component that a film of a polyimide resin obtained by an equimolar reaction of the aromatic tetracarboxylic dianhydride and the aromatic diamine compound constituting the block component will be softened and lose its original film shape when the film fixed in a fixing metal frame was heated at 450° C. for 1 minute. The polyimide film for the evaluation on whether the block component is thermoplastic or not can be prepared by a well-known method with a maximum curing temperature of 300° C. and a curing time of 15 min. A more specific example is a method adopted in the later-described Example in order to produce a polyimide film for the evaluation of thermoplasticity of a block component. The evaluation of thermoplasticity of a block component can be performed by preparing a polyimide film from the block component as described above and determining a temperature at which the polyimide film is melted. The thermoplastic block component is such that the thus prepared polyimide film film including the thermoplastic polyimide block component will be softened and lose its shape at heat application preferably in a range of 250° C. to 450° C., and more preferably in a range of 300° C. to 400° C. If this temperature was too low, it would be difficult to attain a non-thermoplastic polyimide film finally. If this temperature was too high, it would be difficult to attain the excellent adherability, which is the effect of the present invention.

The solvent to be used in the synthesis of the polyamic acid may be any solvent that can dissolve the polyamic acid therein. Examples of the solvent encompass amide-based solvents such as N,N-dimethylformamide, N,N-dimethylacetoamide, N-methyl-2-pyrrolidone. N,N-dimethylformamide and N,N-dimethylacetoamide are especially preferable.

Moreover, the polyimide film may be produced with a filler added therein in order to attain better film properties such as slidability, heat conductivity, electric conductivity, corona resistance, loop stiffness, etc. Any kind of filler may be used. Preferable examples of the filler encompass silica, titanium oxide, alumina, silicon nitride, boron nitride, dibasic calcium phosphate, calcium phosphate, mica, and the like.

The diameter of the filler particles may be determined depending on the film properties to be modified and the type of filler, and is thus not particularly limited. The average particle diameter is usually 0.05 to 100 μm, preferably 0.1 to 75 μm, more preferably 0.1 to 50 μm, and most preferably 0.1 to 25 μm. When the average diameter is below this range, the effect of modification is not readily exhibited. At an average diameter beyond this range, the surface quality (i.e., uniformity in thickness) and/or the mechanical properties may be significantly degraded. The amount by part (amount) of the filler to be added is determined of the film properties to be modified and the diameter of the filler particles and is thus not particularly limited. The amount of the filler added is usually 0.01 to 100 parts by weight, preferably 0.01 to 90 parts by weight, and more preferably 0.02 to 80 parts by weight per 100 parts by weight of polyimide. At a filler content below this range, the effect of the modification by the use of the filler may not be sufficiently exhibited. At a filler content beyond this range, the mechanical properties of the film may be significantly degraded.

The filler may be added by any method. The examples of the method include:

1. Method of adding the filler to the polymerization solution before or during the polymerization;

2. Method of adding and kneading the filler into the polymerization solution with a three-shaft roller after completion of the polymerization; and

3. Method including preparing a dispersion liquid containing the filler in advance and adding the dispersion liquid into a polyamic acid organic solvent solution.

Any method may be employed for the addition of the filler. However, the method including preparing a dispersion liquid containing the filler in advance and adding (especially right before the film formation) the dispersion liquid into a polyamic acid solution is preferable because contamination of the production line with the filler in this method is least severe. In the preparation of the dispersion liquid, it is preferable to use the same solvent as the polymerization solvent of the polyamic acid. In order to sufficiently disperse the filler and stabilize the dispersion state, a dispersant, a thickener, or the like may be used in amounts that do not adversely affect the properties of the film.

### (2. Polyimide Film Production)

It is possible to adopt a conventionally known method in the production of the polyimide film from the polyamic acid solution. Examples of the method encompass “thermal imidization method” and “chemical imidization method”. The “thermal imidization method” is a method of facilitating the imidization only by heat application without using a ring-closing dehydrating agent or the like. The “chemical imidization method” is a method of facilitating the imidization by the effect of a chemical converting agent and/or a catalyst to the polyamic acid solution.

Here, what is meant by the term “chemical converting agent” is a ring-closing dehydrating agent (which may be referred to as a “dehydrating agent” simply), which causes ring-closing dehydration in the polyamic acid. For example, the chemical converting agent may be an aliphatic acid anhydride, an aromatic acid anhydride, a N,N′-dialkylcarbodiimide, a low aliphatic halide, a low aliphatic anhydride halide, an aryl phosphoric dihalide, a thionyl halide, and mixtures of two or more of them. For high availability and low cost, aliphatic acid anhydrides such as acetic anhydride, propionic anhydride, lactic anhydride, etc. and mixtures of two or more of them are preferable among these dehydrating agents.

Moreover, what is meant by the “catalyst (which may be referred to as “imidization catalyst”) is a component that facilitates the ring-closing dehydration in the polyamic acid. Examples of the catalyst encompass aliphatic tertiary amine, aromatic tertiary amine, heterocyclic tertiary amine, etc. Among the catalysts listed above, a catalyst selected from the heterocyclic tertiary amines is especially preferably because of its high catalytic activity. Typical examples thereof are quinoline, isoquinoline, β-picoline, pyridine, etc.

The polyimide film may be produced by either the thermal imidization method or the chemical imidization method. However, the imidization of the chemical imidization method tends to be easier to obtain a polyimide film having the properties suitable for the present invention. In addition, The polyimide film may be produced by using the thermal imidization method and the chemical imidization method in combination.

In the present invention, it is especially preferable that the production process of the polyimide film include:

a) reacting an aromatic diamine and an aromatic tetracarboxylic dianhydride in an organic solvent, so as to obtain a polyamic acid solution;

b) flow-casting, on a support, a film formation dope containing the polyamic acid solution;

c) heating the film formation dope on the support and peeling a gel film from the support; and

d) further heating the gel film so as to imidize residual amic acid and dry the gel film.

In the above process, a curing agent containing a chemical converting agent or an imidization catalyst. Typical examples of the chemical converting agent include acid anhydrides such as acetic anhydride. Typical examples of the imidization catalyst include tertiary amines such as isoquinoline, β-picoline, pyridine, etc.

In the following, a preferable embodiment is described to explain the production process of the polyimide film. In the embodiment, the chemical imidization is explained for example. It should be noted that the present invention is not limited to the following arrangement described by way of example, and the film formation condition and heating condition may be varied as appropriate according to the kinds of the polyamic acid, film thickness, etc.

The chemical converting agent and imidization catalyst may be added into the polyamic acid solution at a low temperature thereby to prepare a film formation dope. Then, the film formation dope is cast on a support such as a glass plate, an aluminum foil, endless stainless-steel belt, stainless-steel drum, or the like, thereby forming a film thereof on the support. The film on the support is heated in a temperature in a range of 80° C. to 200° C., preferably in a range of 100° C. to 180° C. in order to activate the chemical converting agent and the imidization catalyst. Thereby, the film is partially cured and/or dried. Then, the film is removed from the support thereby obtaining a polyamic acid film (hereinafter this film is referred to as a gel film).

The gel film is in an intermediate state in the curing of the polyamic acid to the polyimide. The gel film is a self-supportive film. A volatile content of the gel film is expressed as formula (2):

(A−B)×100/B (2)

where A is a weight of the gel film, and B is a weight of the gel film after heated at 450° C. for 20 min.

The volatile content of the gel film is in a range of 5 to 500 wt. %, preferably in a range of 5 to 200 wt. %, and more preferably in a range of 5 to 150 wt. %.

It is preferable to use a film in these ranges. In a baking process, there is a risk of film breakage, lack of uniformity in color tone of the film due to unevenly drying the film, and property variation, etc.

The amount of the chemical converting agent is in a range of 0.5 to 5 mol, and preferably in a range of 1.0 to 4 mol per unit of amic acid in the polyamic acid.

Moreover, the amount of the imidization catalyst is in a range of 0.05 to 3 mol, and preferably in a range of 0.2 to 2 mol per unit of amic acid in the polyamic acid.

The chemical imidization would be insufficient when the amounts of the chemical converting agent and imidization catalyst are below the ranges. The insufficient chemical imidization would result in the film breakage during the baking or low mechanical strength. On the other hand, the imidization would proceed too fast when the amounts of the chemical converting agent and imidization catalyst are above the ranges. The too-fast imidization would make it difficult to cast the solution into the film-like shape.

The gel film held at its ends is dried. By being held at its ends, the gel film can avoid the shrinkage due to the curing. The drying removes water, residual solvent, residual converting agent, and catalyst from the film, and completes the imidization of the residual amic acid. Thereby, the polyimide film of the present invention can be obtained.

The drying is preferably carried out at a temperature in a range of 400 to 650° C. for a time period in a range of 5 to 400 sec. Drying carried out at a temperature higher than the range and/or for a time period longer than the range would possibly cause thermal deterioration in the film. On the other hand, drying carried out at a temperature lower than the range and/or for a time period shorter than the range would possibly fail to attain the desired properties in the polyimide film thus produced.

Moreover, the heat treatment of the film may be carried out with the film stretched at a lowest tension necessary for conveying the film. This lowers an internal stress remained in the film. The heat treatment may be carried out during the film production process, or may be carried out in addition to the process. The heating condition cannot be specified because the heating condition varies depending on film property or apparatus to use. The internal stress can be alleviated by heating at a temperature generally not less than 200° C. but not more than 500° C., preferably not less than 250° C. but not more than 500° C., especially preferably not less than 300° C. but not more than 450° C., for a time period in a range of 1 to 300 sec, preferably in a range of 2 to 250 sec, and especially preferably in a range of 5 to 200 sec.

The polyimide film thus obtained in this way finally should be non-thermoplastic. Here, what is meant by “non-thermoplastic polyimide” is a polyimide resin that will not be melt or deformed at heat application. In practice, the determination on whether a polyimide is non-thermoplastic or not can be done by evaluating an outer appearance of a film prepared from the polyimide after heating the film, being held with a metal frame, at 450° C. for 1 min. If the film is not melted or shrunk after the heat application whereby the outer appearance of the film is maintained, it is determined that the polyimide constituting the film is a non-thermoplastic polyimide. Therefore, the polyimide film can be designed to have the monomer composition so as to be non-thermoplastic.

(3. Adherability of Polyimide Film according to the Present Invention)

The polyimide film according to the present invention, which is obtained in the manner described above does not need a special treatment to its film surface to exhibit a high adherability for a metal foil laminated thereto via an adhesive layer. Especially, the polyimide film according to the present invention shows a high adherability for the metal foil laminated thereto even if via an adhesive containing a thermoplastic polyimide, which is generally poorer in adhesiveness than a thermosetting resin. The adhesion strength between the polyimide film according to the present invention and the metal film can be expressed as follows for example. With the polyimide film according to the present invention, any surface treatment to the polyimide film is unnecessary to attain such a property that a metal foil peel strength of 15 Ncm or more is required to peel the metal foil from a laminate at 90° peeling angle and a metal foil peel strength of 10 Ncm or more is required to peel the metal foil from the laminate at 180° peeling angle, where in the laminate the metal foil is laminated with the polyimide film via the adhesive layer having the thermoplastic polyimide.

With the polyimide film according to the present invention, the laminate can maintain the adhesion strength well even after being treated with a temperature of 121° C. under relative humidity of 100% (hereinafter, written as “100% R.H.”) for 96 hours. For example, with the polyimide film according to the present invention, any surface treatment to the polyimide film is unnecessary to attain such a property that metal foil peel strengths required to peel the metal foil from a laminate at 90° peeling angle and at 180° peeling angle after treating the laminate with the 96-hour treatment with 121° C. and 100% R.H. are 85% or more of the metal foil peel strengths required to peel the metal foil from the laminate at 90° peeling angle and at 180° peeling angle before the treatment, where in the laminate the metal foil is laminated with the polyimide film via the adhesive layer having the thermoplastic polyimide.

Moreover, the laminate with the polyimide film according to the present invention can maintain the adhesion strength well even after heating the laminate at 150° C. for 500 hours. For example, with the polyimide film according to the present invention, any surface treatment to the polyimide film is unnecessary to attain such a property that metal foil peel strengths required to peel the metal foil from a laminate at 90° peeling angle and at 180° peeling angle heating the laminate at 150° C. for 500 hours are 85% or more of the metal foil peel strengths required to peel the metal foil from the laminate at 90° peeling angle and at 180° peeling angle before the heating, where in the laminate the metal foil is laminated with the polyimide film via the adhesive layer having the thermoplastic polyimide.

As described above, the polyimide film according to the present invention can show an excellent adherability without requiring any surface treatment. Needless to say, the polyimide film according to the present invention may be subjected to a surface treatment.

### EXAMPLE

Hereinafter, the present invention will be described below in more details by way of Examples, which are not to limit the present invention.

The following explains how it was carried out to evaluate glass transition temperatures of thermoplastic polyimides, coefficient of thermal expansion and plasticity of polyimide films, metal foil peel strength of a flexible metal-clad laminate board in Synthetic Examples, Examples, and Comparative Examples.

(Glass Transition Temperature)

The glass transition temperature was measured with DMS6100 manufactured by SII Nanotechnology Inc. The temperature at the inflection point of the storage modulus was assumed as the glass transition temperature.

Measured Sample Range; Width: 9 mm, Distance between Holding Tools: 20 mm

### Measured Temperature Range; 0 to 440° C.

### Heating Rate; 3° C./min

### Strain Amplitude; 10 μm

Frequencies for measurement; 1, 5, and 10 Hz

### Minimum Tension/Compressive Force; 100 mN

### Tension/Compression Gain; 1.5

### Initial Value of Force Amplitude; 100 mN

(Coefficient of Thermal Expansion Coefficient of Polyimide Film)

The coefficient of thermal expansion of the polyimide film obtained was measured by using Thermo-mechanical Analysis Instrument TMA/SS6100 manufactured by SII Nanotechnology Inc. To measure the coefficient of thermal expansion, the polyimide film was heated from 0 to 460° C., and then cooled down to 10° C. After that, the polyimide film was heated at the heating rate of 10° C./min. The polyimide film was measured at 100° C. and 200° C. in the second heating. The measurement values were averaged to work out the coefficient of thermal expansion of the polyimide film. The measurement of coefficient of thermal expansion was performed to the MD direction (longitudinal direction) and the TD direction (width direction) of the polyimide film.

### Sample Size; Width 3 mm, Length 10 mm

### Load; 29.4 mN

### Temperature Range in Measurement: 0 to 460° C.

### Heating Rate; 10° C./min

(Evaluation of Plasticity)

The evaluation of plasticity was performed by subjection a result polyimide film to a heat treatment of 450° C. for 1 min., the polyimide film being sized of 20×20 cm and held in a stainless steel (SUS) frame of a square shape (outer periphery 20×20 cm, inner periphery 18×18 cm). One that maintained its polyimide film shape after the heat treatment was determined as being non-thermoplastic, while one that was shrunk or extended was determined as being thermoplastic.

(Metal Foil Peel Strength: Initial Bonding Strength)

In accordance with Japanese Industrial Standard C6471, “6.5. Peel Strength”, a sample was prepared, a load was measured, which was necessary to peel metal foil portion 5 mm wide at a peeling angle of 180° and 50 mm/min. In a similar manner, a load was measured, which was necessary to peel metal foil portion 1 mm wide at a peeling angle of 90° and 50 mm/min.

(Metal Foil Peel Strength: Post-PCT (Pressure Cooker Test) Bonding Strength)

In a pressure cooker testing apparatus made by Hirayama Manufacturing Co., Ltd. (Product Name: PC-422 RIII), a sample prepared in the same manner as in the initial bonding strength was introduced and kept under conditions of 121° C. and 100% R.H. for 96 hours. After being taken out of the pressure cooker testing apparatus, the sample was measured in the same manner as in the initial bonding strength.

(Metal Foil Peel Strength: Post-Heat Treatment Bonding Strength)

In an oven that was set at 150° C., a sample prepared in the same manner as in the initial bonding strength was introduced and kept for 500 hours. After being taken out of the oven, the sample was measured in the same manner as in the initial bonding strength.

### Synthetic Example 1

### Synthesis of Thermoplastic Polyimide Precursor

To a 2,000 mL glass flask, 780 g of DMF and 117.2 g of bis[4-(4-aminophenoxy)phenyl]sulfone (hereinafter, also referred to as BAPS) were added. While the resulting mixture was being stirred in a nitrogen atmosphere, 71.7 g of 3,3′4,4′-biphenyltetracarboxylic dianhydride (BPDA) was gradually added to the mixture. Subsequently, 5.6 g of 3,3′,4,4′-ethyleneglycol dibenzoate tetracarboxylic dianhydride (hereinafter, also referred to as TMEG) was added, and the resulting mixture was stirred in an ice bath for 30 minutes. A solution of 5.5 g of TMEG in 20 g of DMF was separately prepared and gradually added to the reaction solution while monitoring the viscosity under stirring. The addition and the stirring were ceased when the viscosity reached 3,000 poise. A polyamic acid solution was thereby obtained.

The polyamic acid solution thereby obtained was flow-cast on a 25 μm PET film (Cerapeel HP, produced by Toyo Metallizing Co., Ltd.) so that the final thickness would be 20 μm, and dried at 120° C. for 5 minutes. The resulting self-supporting film after the drying was peeled from the PET film, held onto a metal pin frame, and dried at 150° C. for 5 minutes, at 200° C. for 5 minutes, at 250° C. for 5 minutes, and then at 350° C. for 5 minutes. The glass transition temperature of thus obtained single-layer sheet was measured and found to be 270° C.

### Examples 1 to 6

In a reaction system kept at 5° C., 4,4′-diaminodiphenylether (hereinafter also referred to 4,4′-ODA) and bis{4-(4-aminophenoxy)phenyl}propane (hereinafter also referred to BAPP) in a molar ratio shown in Table 1 were added to N,N-dimethylformamide ((hereinafter also referred to DMF), and stirred. After dissolution of 4,4′-ODA and BAPP was visually checked, benzophenonetetracarboxylic dianhydride (hereinafter, also referred to as BTDA) was added in a molar ratio shown in Table 1 and stirred for thirty minutes.

Then, pyromellitic dianhydride (hereinafter, also referred to as PMDA) was added in a molar ratio shown in Table 1 “PMDA (1st)” and stirred for thirty minutes. Thereby, a thermoplastic polyimide precursor block component was formed. Subsequently, p-phenylenediamine (hereinafter, also referred to as p-PDA) was added in a molar ratio shown in Table 1 and dissolved therein. Subsequently, PMDA was again added in a molar ratio shown in Table 1 “PMDA (2nd)” and stirred for thirty minutes.

TABLE 1

| | | | | PMDA | | PMDA |
|---|---|---|---|---|---|---|
| Example | 4,4′-ODA | BAPP | BTDA | (1st) | p-PDA | (2nd) |
| 1 | 20 | 25 | 20 | 20 | 55 | 57 |
| 2 | 30 | 20 | 20 | 25 | 50 | 52 |
| 3 | 30 | 20 | 10 | 35 | 50 | 52 |
| 4 | 20 | 30 | 20 | 25 | 50 | 52 |
| 5 | 10 | 40 | 20 | 25 | 50 | 52 |
| 6 | 20 | 30 | 10 | 35 | 50 | 52 |

At the end, 3 mol % of PMDA was dissolved into DMF to prepare a solution with 7% solid content. The solution prepared was gradually added to the above-mentioned reaction solution, while watching for an increase in the viscosity. The polymerization was ceased when the viscosity reached 4,000 poise at 20° C.

To this polyamic acid solution, an imidization accelerator composed of acetic anhydride/isoquinoline/DMF (ratio of 2.0/0.3/4.0 based on weight) was added so as to be a ratio of 45% based on weight to the polyamic acid solution and continuously stirred by a mixer. The resulting mixture was extruded from a T die and flow-cast on an endless belt made of stainless steel that runs 20 mm below the die. This resin film was heated at 130° C. for 100 seconds. The resulting self-supporting gel film (residual volatile content: 30 wt %) was peeled off from the endless belt. This resulting gel film was held with a tenter clip and then subject to drying and imidization by heat application of 300° C. for 30 sec., 400° C. for 30 sec, and 500° C. for 30 sec. As a result, a polyimide film having a thickness of 18 μm was obtained. The polyimide film thus obtained was non-thermoplastic. To the prepolymer prepared by the first PMDA addition with stirring, a DMF solution containing PMDA by 7 wt % was gradually added until a viscosity of 3000 poise was reached. Thereby, a polyamic acid solution was obtained. The polyamic acid solution thereby obtained was flow-cast on a 25 μm PET film (Cerapeel HP, produced by Toyo Metallizing Co., Ltd.) so that the final thickness would be 20 μm, and dried at 120° C. for 5 minutes. The resulting self-supporting film after the drying was peeled from the PET film, held onto a metal pin frame, and dried at 200° C. for 5 minutes, at 250° C. for 5 minutes, and at 300° C. for 5 minutes. The resultant polyimide film was evaluated in plasticity and found to be thermoplastic.

In Example 1, it took 20 hours from the start of the polymerization to obtain a film of 10,000 m long.

On one side of the resultant polyimide film, the polyamic acid obtained in Synthetic Example 1 was applied by using a comma coater so that the final thermoplastic polyimide layer (adhesion layer) would have a one-side thickness of 3.5 μm. After that, the polyimide film with the adhesive layer thereon was passed through an infra-red heater furnace at atmospheric temperature of 390° C. for 20 sec for thermal imidization. Thereby an adhesive film was obtained.

An 18 μm rolled copper foil (BHY-22B-T, produced by Japan Energy Corporation) was put on the adhesive layer of the resulting adhesive film, and then a protective material (Apical 125NPI produced by Kaneka Corporation) was put thereon. Then, the resultant adhesive film with adhesive layer and the protective layer thereon was passed through a thermal roll laminating apparatus that was set to the laminating temperature of 380° C.; the laminating pressure of 196 N/cm (20 kgf/cm), the laminating speed of 1.5 m/min. Thereby the adhesive film was laminated with the copper foil.

### Reference Example 1

A polyimide film of 18 μm in thickness was prepared in the same manner as in Example 1, except that the polymerization of the polyamic acid was carried out with 3,4′-diaminodiphenylether (also referred to as “3,4′-ODA”) instead of 4,4′-ODA. In Reference Example 1, it took 25 hours from the start of the polymerization to obtain a film of 10,000 m long.

### Comparative Example 1

A polyimide film (Apical 18HP (untreated) produced by Kaneka Corporation) of 18 μm in thickness, which had not been subjected to plasma treatment, was provided with an adhesive layer thereon and laminated with a copper foil in the same manner as in Examples.

### Comparative Example 2

A polyimide film (Apical 20NPI (untreated) produced by Kaneka Corporation) of 20 μm in thickness, which had not been subjected to plasma treatment, was provided with an adhesive layer thereon and laminated with a copper foil in the same manner as in Examples.

### Comparative Example 3

A polyimide film (Apical 18HPP produced by Kaneka Corporation) of 18 μm in thickness, whose surface had been subjected to plasma treatment, was provided with an adhesive layer thereon and laminated with a copper foil in the same manner as in Examples.

### Comparative Example 4

A polyimide film (Apical 20NPP produced by Kaneka Corporation) of 20 μm in thickness, whose surface had been subjected to plasma treatment, was provided with an adhesive layer thereon and laminated with a copper foil in the same manner as in Examples.

The polyimide films obtained in Examples and Comparative Examples were evaluated on the properties. The results of the evaluation are shown in Table 2.

| | Coefficient | | | | | | | | | | | |
|---|---|---|---|---|---|---|---|---|---|---|---|---|
| | of Thermal | | | | | | | | | | | |
| | Expansion | | Bonding Strength (N/cm) | | | | | | | | | |
| | of Film | | 90° peeling | | | | | 180° peeling | | | | |
| | (ppm/° c.) | | (retention in parentheses) | | | | | (retention in parentheses) | | | | |
| | MD | TD | Initial | POST-PCT | | POST-HEATING | | Initial | POST-PCT | | POST-HEATING | |
| Ex. 1 | 7.0 | 6.8 | 16.0 | 15.2 | (95%) | 15.4 | (96%) | 16.0 | 15.2 | (95%) | 15.5 | (97%) |
| Ex. 2 | 7.5 | 7.7 | 15.0 | 14.7 | (98%) | 14.4 | (96%) | 15.6 | 15.3 | (98%) | 15.3 | (98%) |
| Ex. 3 | 9.2 | 9.5 | 14.5 | 14.1 | (97%) | 14.1 | (97%) | 14.0 | 13.3 | (95%) | 13.3 | (95%) |
| Ex. 4 | 12.5 | 12.0 | 14.7 | 14.0 | (95%) | 14.1 | (96%) | 14.5 | 13.5 | (93%) | 13.5 | (93%) |
| Ex. 5 | 12.6 | 12.4 | 13.3 | 13.0 | (98%) | 12.9 | (97%) | 12.5 | 12.1 | (97%) | 11.9 | (95%) |
| Ex. 6 | 10.6 | 10.4 | 13.0 | 12.5 | (96%) | 12.6 | (97%) | 12.0 | 11.5 | (96%) | 11.5 | (96%) |
| Com. Ex. 1 | 12.4 | 12.0 | 1.0 | 0 | (0%) | 0 | (0%) | 1.5 | 0 | (0%) | 0 | (0%) |
| Com. Ex. 2 | 16.4 | 15.5 | 2.2 | 0 | (0%) | 0 | (0%) | 2.4 | 0 | (0%) | 0 | (0%) |
| Com. Ex. 3 | 12.5 | 12.1 | 8.3 | 6.1 | (73%) | 8.0 | (96%) | 9.6 | 8.4 | (88%) | 9.3 | (97%) |
| Com. Ex. 4 | 16.6 | 15.8 | 11.5 | 9.3 | (81%) | 10.7 | (93%) | 12.0 | 9.8 | (82%) | 11.2 | (93%) |

As demonstrated in Comparative Examples 1 and 2, the polyimide films whose surfaces were untreated were extremely low in the initial bonding strength and showed no adherability to the copper foil after the PCT or heating treatment. By contrast, the polyimide films of Examples 1 to 6 had high initial bonding strengths against the 90° peeling and 180° peeling, and showed no significant reduction in the adhesion strengths even after the PCT or heating treatment. Moreover, the initial bonding strengths and the retention of the bonding strength after the PCT or the heating treatment in the polyimide films of Examples 1 to 6 were as high as those of the polyimide films of Comparative Examples whose surfaces were subjected to the plasma treatment.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

Unlike the conventional polyimide film, the polyimide film of the present invention does not need a surface treatment to be adherable, for example, in order to offer good adhesion in laminating with a metal foil via an adhesive agent. Especially, the polyimide film of the present invention shows high adherability to a metal foil even if an adhesive layer containing a thermoplastic polyimide, which is poorer in adhesiveness than a thermosetting resin, is used. Moreover, the polyimide film according to the present invention show no significant reduction in the adherability to the metal foil even if being subjected to high temperature or high humidity. Therefore, according to the present invention, it is possible to solve the problems of the increases in the number of steps and in production cost caused due to the surface treatment in the production of flexible metal-clad laminate boards etc.

Therefore, the present invention is applicable not only to fields in which various resin products such as polyimide-containing adhesive films and laminates typically are produced, but also to fields which relates to production of electronic components using such adhesive films and laminates.

1. A non-thermoplastic polyimide film prepared from a solution containing a polyamic acid obtained by reacting aromatic diamines and aromatic acid dianhydrides,
the aromatic diamines including 4,4′-diaminodiphenylether and bis{4-(4-aminophenoxy)phenyl}propane, and the solution containing the polyamic acid being produced by a producing method comprising the steps of:
(A) preparing a flexible thermoplastic block prepolymer component having an amino group or an acid dianhydride group on each end by reacting, in an organic polar solvent, an aromatic acid dianhydride component and an aromatic diamine component, one of which is greater in molar amount than the other; and
(B) synthesizing a solution containing a polyamic acid by (i) adding an aromatic acid dianhydride component and an aromatic diamine component to the solution containing the flexible thermoplastic block prepolymer component obtained in the step (A) to attain a substantial equimolar ratio of the aromatic acid dianhydride component and the aromatic diamine component in an overall production process of the solution containing the polyamic acid, and (ii) reacting the aromatic acid dianhydride component and the aromatic diamine component.

2. The non-thermoplastic polyimide film as set forth in claim 1, wherein the aromatic diamine component used in the step (A) is a flexible diamine.

3. The non-thermoplastic polyimide film as set forth in claim 2, wherein the aromatic diamine component used in the step (B) is a rigid diamine.

4. The non-thermoplastic polyimide film as set forth in claim 2, wherein the flexible diamine comprises 4,4′-diaminodiphenylether and/or bis{4-(4-aminophenoxy)phenyl}propane.

5. The polyimide film as set forth in claim 4, wherein 4,4′-diaminodiphenylether is used by 10 mol % or more of the whole diamine component used in the overall production process of the solution containing the polyamic acid.

6. The polyimide film as set forth in claim 4, wherein bis{4-(4-aminophenoxy)phenyl}propane is used by 10 mol % or more of the whole diamine component used in the overall production process of the solution containing the polyamic acid.

7. The polyimide film as set forth in claim 1, wherein benzophenonetetracarboxylic dianhydride is used as the aromatic acid dianhydride in the step (A).

8. The polyimide film as set forth in claim 7, wherein the benzophenonetetracarboxylic dianhydride is used by 5 mol % or more of the whole acid dianhydride component used in the overall production process of the solution containing the polyamic acid.

9. The polyimide film as set forth in claim 1, wherein a laminate prepared by laminating the polyimide film with a metal foil via an adhesive layer containing a thermoplastic polyimide has a metal-foil peel strength of 15 N/cm or more at 90° peeling and of 10 N/cm or more at 180° peeling, where the polyimide film is not surface-treated.

10. The polyimide film as set forth in claim 1, wherein a laminate prepared by laminating the polyimide film with a metal foil via an adhesive layer containing a thermoplastic polyimide is 85% or more in metal-foil peel strengths at 90° peeling and at 180° peeling after being treated with a temperature of 121° C. and 100% relative humidity for 96 hours compared with before the treatment, where the polyimide film is not surface-treated.

11. The polyimide film as set forth in claim 1, wherein a laminate prepared by laminating the polyimide film with a metal foil via an adhesive layer containing a thermoplastic polyimide is 85% or more in metal-foil peel strengths at 90° peeling and at 180° peeling after being treated with a temperature of 150° C. for 500 hours compared with before the treatment, where the polyimide film is not surface-treated.

12. The non-thermoplastic polyimide film as set forth in claim 1, wherein when the polyimide film is heated at 450° C. for 1 minute while being held with a metal frame, the polyimide film is not melted or shrunk and an outer appearance of the polyimide film is maintained.
